(19) United States
(12) Patent Application Publication
(10) Pub. No.: US 2003/0131136 A1
(43) Pub. Date: Jul. 10, 2003

(54) Method and apparatus for emulating an OS-supported communication device to enable remote debugging

(76) Inventors: Theodore F. Emerson, Houston, TX (US); David Heinrich, Tomball, TX (US); Christopher J. Frantz, Houston, TX (US); Andrew Brown, Houston, TX (US)

Correspondence Address: Michael G. Fletcher, Fletcher, Yoder & Van Someren, P.O. Box 692289, Houston, TX, 77269-2289, US

(21) Appl. No.: 10/037,501

(22) Filed: Jan. 4, 2002

(51) Int. Cl. G06F 15/16; G06F 15/173

(52) U.S. Cl. 709/250; 709/223

(57) ABSTRACT

The disclosure relates to a remote server management controller that is adapted to be incorporated into a managed server. The disclosed embodiments allow a remote user to communicate with the managed server using out-of-band management communications that are not dependent on the OS of the managed server. The user may obtain management data from the OS or perform other functions remotely by causing the managed server to redirect data from its local communications interfaces to communications interfaces that are available to the remote user.

### BACKGROUND OF THE INVENTION

1. Field of the Invention

This invention relates generally to monitoring and correcting failure conditions in networked computer systems and, more particularly, to remote server management.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing the gigahertz (one billion operations per second) and continuing well beyond.

Productivity has also increased tremendously because of the explosion in development of software applications. In the early days of the PC, people who could write their own programs were practically the only ones who could make productive use of their computers. Today, there are thousands and thousands of software applications ranging from games to word processors and from voice recognition to web browsers.

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share internet connections, resulting in significant cost savings. Networked computing has revolutionized the way in which business is conducted across the world.

Not surprisingly, the evolution of networked computing has presented technologists with some challenging obstacles along the way. One obstacle is connecting computers that use different operating systems (“OSes”) and making them communicate efficiently with each other. Each different OS (or even variations of the same OS from the same company) has its own idiosyncrasies of operation and configuration. The interconnection of computers running different OSes presents significant ongoing issues that make day-to-day management of a computer network challenging.

Another significant challenge presented by the evolution of computer networking is the sheer scope of modem computer networks. At one end of the spectrum, a small business or home network may include a few client computers connected to a common server, which may provide a shared printer and/or a shared internet connection. On the other end of the spectrum, a global company's network environment may require interconnection of hundreds or even thousands of computers across large buildings, a campus environment, or even between groups of computers in different cities and countries. Such a configuration would typically include a large number of servers, each connected to numerous client computers.

Further, the arrangements of servers and clients in a larger network environment could be connected in any of a large number of topologies that may include local area networks (“LANs”), wide area networks (“WANs”) and municipal area networks (“MANs”). In these larger networks, a problem with any one server computer (for example, a failed hard drive, failed network interface card or OS lock-up to name just a few) has the potential to interrupt the work of a large number of workers who depend on network resources to get their jobs done efficiently. Needless to say, companies devote a lot of time and effort to keeping their networks operating trouble-free to maximize productivity.

An important aspect of efficiently managing a large computer network is to maximize the amount of analysis and repair that can be performed remotely (for example, from a centralized administration site). Tools that facilitate remotely analyzing and servicing server problems help to control network management costs by reducing the number of network management personnel required to maintain a network in good working order. Remote server management also makes network management more efficient by reducing the delay and expense of analyzing and repairing network problems. Using remote management tools, a member of the network management team may identify problems and, in some cases, solve those problems without the delay and expense that accompanies an on-site service call to a distant location.

Remote management tools can communicate with a managed server using either (1) in-band communication or (2) out-of-band communication. In-band communication refers to communicating with the server over a standard network connection such as the managed server's normal Ethernet connection. In-band communication with the server is, accordingly, only possible when the server is able to communicate over its normal network connection. Practically speaking, this limitation restricts in-band communication to times when the OS of the managed server is operational (online).

Out-of-band communication, which is not performed across the managed server's normal connection to the network, is a much more powerful tool for server management. In out-of-band communication, a “back door” communication channel is established by a remote server management tool (such as a remote console or terminal emulator) using some other interface with the server (such as (1) through the server's modem, (2) via a direct connection to a serial port, (3) through an infrared communication port, or (4) through an management Ethernet interface or the like).

In a sense, out-of-band communication is like opening an unobtrusive window through which the inner workings of the operation of the managed server may be observed. After the out-of-band communication link with the server is established, the remote server management tool communicates with the server to obtain data that will be useful to analyze a problem or potential problem. After a problem has been analyzed, out-of-band communication may be possible to control the managed server to overcome the problem or potential problem.

In addition to the distinction between in-band and out-of-band communication with a managed server, another important distinction is whether the managed server is online or offline. The term “online” refers to a managed server in which the OS is up and running. The managed server is said to be “offline” if its OS is not up and running. For the purpose of explaining the present technique, communications with a managed server will take place in one of these four states: (1) in-band online; (2) in-band offline; (3) out-of-band online; and (4) out-of-band offline.

An important goal in the development of remote server management tools is to increase the number of server problems that may be analyzed and repaired remotely (that is, without requiring direct, on-site intervention by a member of the network management team). To facilitate that goal, it is highly desirable to have a network management tool that is able to capture the maximum amount of information from a managed server in the maximum range of operational states of the server (for example, not powered up, fully operational or powered but locked up) and to allow control of the managed server based on that data.

Early remote management tools were able to analyze and address a relatively narrow range of managed server problems. One of the first remote server management tools had the ability to reset a managed server remotely by cycling power to turn the server off and on again via an out-of-band communication session over a phone line. In this way, a managed server could be reset whether in an online or offline condition. This tool, however, did not have the ability to assimilate data about the operation of the managed server or to analyze the cause of the managed server's failure. Accordingly, the principal utility of these early server management tools was to reset the managed server after catastrophic failure. These management tools were not useful for diagnosing subtle problems or preventing future failures.

Later server management tools employed proprietary software agents similar to device drivers to monitor a wide range of conditions in the managed server directly (for example, alerts and management parameters specified by the Simple Network Management Protocol (“SNMP”)). The proprietary software agents in these management tools were designed to pass their data to the OS of the managed server, where it could be retrieved by remote access such as a remote management console application.

The large amount of data accessible by these management tools made them useful for diagnosing the cause of a wide range of server failures and permitting repair of those failures. A shortcoming of these server management tools, however, is that they rely primarily on communication between the managed server's OS and proprietary software agents that monitor conditions in the managed server. This limitation means that the tool is only operational when the managed server is online. Server management tools of this type are, accordingly, of little use in correcting problems in a managed server that is offline.

A still later generation of server management tools relied on a dedicated add-in card comprising an independent processor, memory, and battery backup. The add-in card essentially provided a dedicated management computer for monitoring and controlling the managed server. The dedicated management computer was hosted in the managed server and could communicate with the managed server (host) through an existing communication interface (for example, the PCI bus of the managed server). Such remote management tools could additionally include software agent-based data gathering capability of the type used in earlier agent-based systems previously discussed. In this way, these remote management solutions combine the advantages of deep information gathering capability (software agent-based information gathering technology available when the OS of the managed server is online) with the ability to control the operation of the managed server independently via an out-of-band communication session using the dedicated server management computer system hosted in the managed server.

The add-in card type of remote management tool could also include the capability to capture video data and reset sequences from the managed server for remote display or replay at a later time. The capture of video data is facilitated by the close integration of a remote management tool with the managed server and the ability of the remote management tool to communicate with the managed server over existing communication links (such as an industry standard PCI bus). The ability of a remote management tool to capture video data from a managed server is a particularly powerful analysis tool because it lets a remote user have “virtual access” to the managed server, just as if the user was physically present and inspecting the managed server in person.

In a typical remote management system employing a dedicated server management computer on an add-in card, a user (typically, a member of the network management team) could initiate an out-of-band session with the dedicated server management computer hosted in the managed server via a remote console application program being executed on a client computer. The dedicated management computer could be addressed by the user to control various aspects of the operation of the managed server via control circuitry connected to the embedded server management computer hosted by the managed server.

The present invention is directed to further improvements of remote server management technology.

### BRIEF DESCRIPTION OF THE DRAWINGS

The foregoing and other advantages of the invention will become apparent upon reading the following detailed description and upon reference to the drawings in which:

FIG. 1 is a block diagram illustrating an exemplary computer network system in which a remote server management controller of the present invention may be practiced;

FIG. 2 is a functional block diagram of an exemplary embodiment of a remote server management controller constructed according to the present invention;

FIG. 3 is a functional block diagram of a virtual communication device (“VCD”).

FIG. 4 is a functional block diagram showing an operating environment of a remote server management controller USB interface in a managed server.

FIG. 5 is a process flow diagram showing one exemplary process for redirecting management communications from the OS of a managed server.

FIG. 6 is a functional block diagram illustrating one exemplary embodiment of the interrupt handling functionality of a remote server management controller.

### DESCRIPTION OF SPECIFIC EMBODIMENTS

The following patents or patent applications are hereby incorporated by reference:

U.S. Pat. No. 5,898,861, entitled “Transparent Keyboard Hot Plug” by Theodore F. Emerson, Jeoff M. Krontz and Dayang Dai;

U.S. Pat. No. 5,790,895, entitled “Modem Sharing” by Theodore F. Emerson and Jeoff M. Krontz;

U.S. patent application Ser. No. 08/733,254, entitled “Video Eavesdropping and Reverse Assembly to Transmit Video Action to a Remote Console” by Theodore F. Emerson, Peter J. Michaels and Jeoff M. Krontz, filed Oct. 18, 1996; and

U.S. patent application Ser. No. 09/438,253, entitled “Operating System Independent Method and Apparatus for Graphical Remote Access” by Theodore F. Emerson and Wesley Ellinger, filed Nov. 12, 1999.

U.S. patent application Ser. No. 09/544,573, entitled “USB Virtual Devices” by Chris Frantz, Andy Brown, E. David Neufeld and Doug Hascall, filed Apr. 6, 2000.

U.S. patent application Ser. No. ______, entitled “Operating System Independent Method and Apparatus for Graphical Remote Access Having Improved Latency” by Theodore F. Emerson and Donald Dykes, filed Jan. 4, 2002.

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

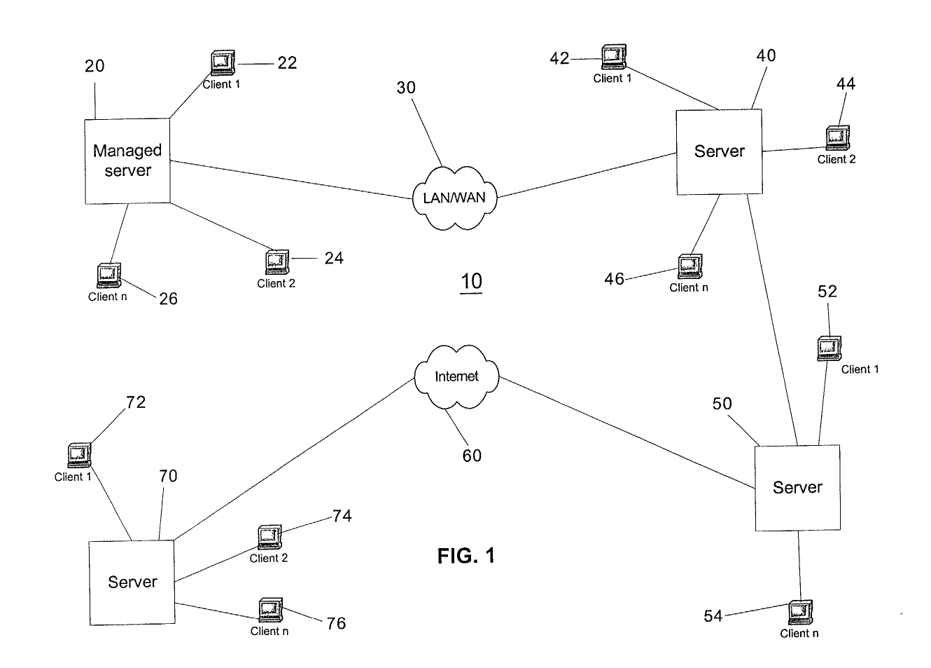

Turning now to the drawings and referring initially to FIG. 1, a block diagram of an exemplary computer network system in which the present invention may be practiced is illustrated and designated using a reference numeral 10. The computer network 10 is intended to illustrate a typical modern computer network configuration with all its complexities and flexibility. A managed server 20 is connected to a plurality of client computers 22, 24 and 26. For purposes of explaining the present embodiment clearly, only one server on the network 10 has been designated as a “managed server.” In practice, those of skill in the art will appreciate that the any or all of the servers in the network 10 could simultaneously include hardware and software devised according to the invention, making those servers “managed servers” as well.

The managed server 20 may be connected to as many as n different client computers. The magnitude of n is a function of the computing power of the managed server 20. If the managed server has large computing power (for example, faster processor(s) and/or more system memory) relative to other servers on the network, it will be able to effectively serve a relatively large number of client computers.

The managed server 20 is connected via a typical network infrastructure 30, which may consist of any combination of hubs, switches, routers and the like. While the network infrastructure 30 is illustrated as being either a local area network (“LAN”) or wide area network (“WAN”), those skilled in the art will appreciate that the network infrastructure 30 may assume other forms such as a municipal area network (“MAN”) or even the Internet.

The network infrastructure 30 connects the managed server 20 to server 40, which is representative of any other server in the network environment of managed server 20. The server 40 may be connected to a plurality of client computers 42, 44 and 46. The server 40 is additionally connected to server 50, which is in turn connected to client computers 52 and 54. The number of client computers connected to the servers 40 and 50 is dependent only on the computing power of the servers 40 and 50, respectively.

The server 40 is additionally connected to Internet 60, which is in turn connected to a server 70. Server 70 is connected to a plurality of client computers 72, 74 and 76. As with the other servers shown in FIG. 1, server 70 may be connected to as many client computers as its computing power will allow.

Those skilled in the art will appreciate that neither the exact topology of the network illustrated in FIG. 1 nor the protocol of network communication (for example, Ethernet or any number of other common protocols) is a crucial aspect of the present invention. Moreover, the network topology shown in FIG. 1 is hypothetical and is shown only to explain the present invention with greater clarity by giving an example of a network environment in which the present invention is useful.

As explained in detail below, the present invention is illustrated as being deployed in a remote server management controller by way of example. The exemplary remote server management controller may be hosted in the managed server 20. The exemplary remote server management controller may be accessed via a remote console application program (or browser program) running on any of the client computers shown in FIG. 1.

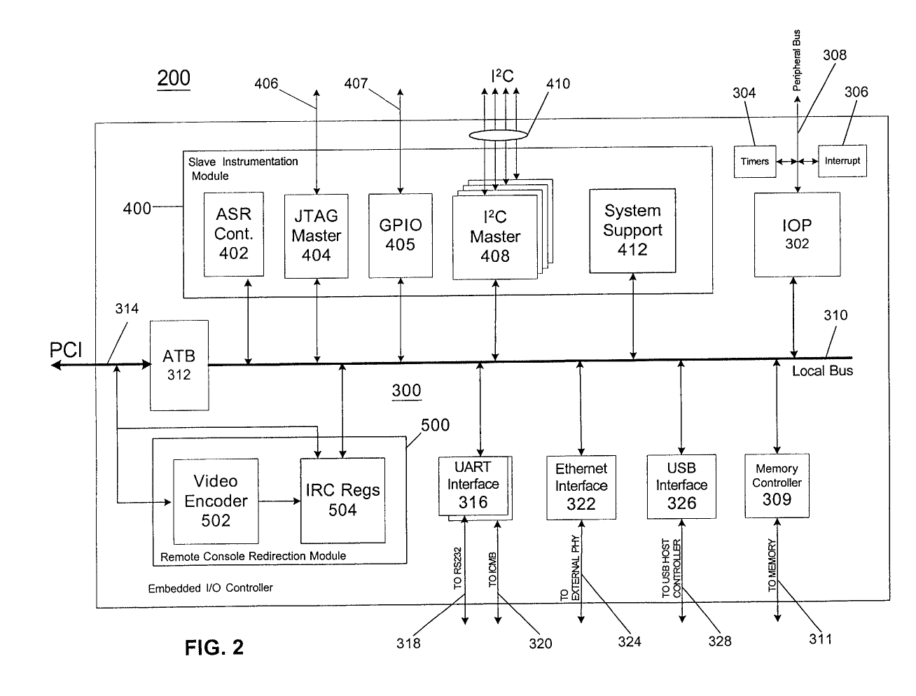

FIG. 2 shows a functional block diagram of one exemplary embodiment of a remote server management controller 200 constructed according to the present invention. The remote server management controller 200 may be implemented in a single application specific integrated circuit (“ASIC”). Alternatively, the remote server management controller 200 may be implemented in a plurality of integrated circuits or discrete components. Those skilled in the art will appreciate that implementation details such as deciding which functional aspects of remote server management controller 200 are implemented in a single ASIC or different ASICs are matters of design choice and not crucial aspects of the present invention.

For purposes of describing the invention clearly, the remainder of this description is written assuming that the remote server management controller 200 is implemented in a single ASIC incorporated into the motherboard of the managed server 20 (FIG. 1). Additionally, any of the client computers shown in FIG. 1 (whether connected directly to managed server 20 or to servers 40, 50 or 70) may establish communication with the remote server management controller 200 through its network connection as is more fully described below. Users may further interface with the remote server management controller 200 through additional communications interfaces such as a modem or other externally available serial connection such as a UART.

The remote server management controller 200 may be implemented so that it is powered and capable of operation whether or not the managed server 20 (FIG. 1) is powered up (turned on) or online. Powering the remote server management controller 200 regardless of whether the host managed server is turned on allows the remote server management controller 200 to monitor, analyze and potentially intervene to correct the widest possible range of system problems that may befall the managed server 20 (FIG. 1).

The logic of the remote server management controller 200 is broken down into three main functional blocks. The first of these three functional blocks is an embedded I/O controller 300, which is essentially an independent computer system that is integrated within the managed server 20 (FIG. 1). The second and third functional blocks of the remote server management controller 200 are a slave instrumentation module 400 and a remote console redirection module 500. As described below, the embedded I/O controller 300 monitors and controls a wide range of conditions in the managed server 20 via the slave instrumentation module 400 and the remote console redirection module 500.

The embedded I/O controller 300 comprises an Input/Output processor (“IOP”) 302, which provides general control and functions as a management processor for the remote server management controller 200. The IOP 302 may be implemented as a 32-bit RISC processor, but other processor implementations may be employed as well. The IOP 302 is operatively coupled to a timer module 304 and an interrupt controller 306 via a peripheral bus 308.

In one exemplary embodiment of the invention, a memory controller 309 is operatively coupled to the internal local bus 310. The memory controller 309 is, in turn, operatively coupled to dedicated memory via a memory interface 311. The dedicated memory may be battery-backed SRAM, SDRAM, ROM, NVRAM or any other appropriate type of memory.

The IOP 302 (located in the embedded I/O controller 300) is operatively coupled to the other functional modules (and many sub-modules) of the remote server management controller 200 via an internal local bus 310. Those of ordinary skill in the field will appreciate that the internal local bus 310 exists to allow communication between and among the logical components of the remote server management controller 200. The implementation details of the internal local bus 310 are a matter of design choice and not a crucial aspect of the present invention.

An address translation and bridging (“ATB”) unit 312 is operatively coupled to the internal local bus 310 and to a PCI bus 314. PCI bus 314 is integral within and operatively coupled with the managed server 20 (FIG. 1). Preferably, the PCI bus 314, which serves as the main communication interface between the managed server 20 (FIG. 1) and the remote server management controller 200, may be configured as a 32-bit, 33 MHz PCI master/slave interface. In a typical system implementation, the remote server management controller 200 resides on the “compatibility” segment of PCI bus 314, but the PCI bus segment on which the remote server management controller is disposed is not a crucial aspect of the invention. The ATB unit 312 is constructed to allow the remote server management controller 200 to decode bus cycles on the PCI bus 314 and to communicate over the PCI bus 314 by initiating PCI bus cycles.

The remote server management controller 200 may be adapted to snoop video traffic via PCI bus 314. Additionally, the PCI bus 314 provides sufficient bandwidth to allow the remote server management controller 200 to actively procure graphical video data as well as textual video data. Although other protocols could be used for the main interconnect between remote server management controller 200 and managed server 20 (FIG. 1), PCI bus 314 is typically used instead of other slower interfaces such as ISA or LPC because the PCI bus 314 allows the transfer of much greater quantities of data. The remote server management controller 200 is capable of independent operation even if the PCI interface 314 is not operational because of a problem with managed server 20 (FIG. 1).

The embedded I/O controller 300 provides a plurality of communication interfaces that can be employed to establish out-of-band communication sessions with the remote server management controller 200. One such communication interface is a UART interface module 316, which is operatively coupled to internal local bus 310. The exemplary UART interface module 316 comprises two standard 16550 UARTs, each of which may provide a separate serial communication interface between the remote server management controller 200 and the external world. Both UARTs are mapped into the address space of the IOP 302 and can be accessed via PCI bus 314 or by the IOP 302. Either UART may be implemented so that it can be reset through a control register in the address space of the IOP 302.

Outputs from the UART interface module 316 are typically routed to transceivers (not shown), where they may be converted into a wide variety of serial interface types. Examples of the types of serial interfaces that may be provided by the UART interface module 316 are a standard RS-232 interface 318 or an interface that complies with the Intelligent Chassis Management Bus (“ICMB”) specification promulgated by Intel Corporation (ICMB interface 320). Those of ordinary skill in the field will appreciate that the RS-232 interface 318 may be used to connect to a wide range of industry standard modems, terminal servers and the like.

In one exemplary embodiment, the RS-232 interface 318 and/or the ICMB interface 320 are accessible to a user from the external chassis of the managed server 20 (FIG. 1). A user may, accordingly, use an external communication device to engage in an out-of-band communication session with the remote server management controller 200 via the UART interface 318 or the ICMB interface 320.

Embedded I/O controller 300 further comprises an Ethernet interface 322, which is operatively coupled to the internal local bus 310. Ethernet interface 322 provides the main external communication interface between the remote server management controller 200 and the outside world. In the exemplary embodiment shown in FIG. 2, the integrated portion of the Ethernet interface 322 includes a MAC (Media Access Controller), inbound and outbound FIFOs and a DMA engine to automatically transfer packets to and from memory. The Ethernet interface 322 requires a connection via interface 324 to an external PHY (not shown) and typical magnetic coupling to couple the PHY to the wire that serves as the transmission media.

Those skilled in the art will appreciate that a user may connect remotely to the remote server management controller 200 via the Ethernet interface 322. Such a connection may be made, for example, using a remote console application running on a client computer anywhere on the network that includes managed server 20 (FIG. 1). The user may, thus, engage in out-of-band communication with the remote server management controller 200 for the purpose of diagnosing, correcting and/or preventing problems with the managed server 20 (FIG. 1).

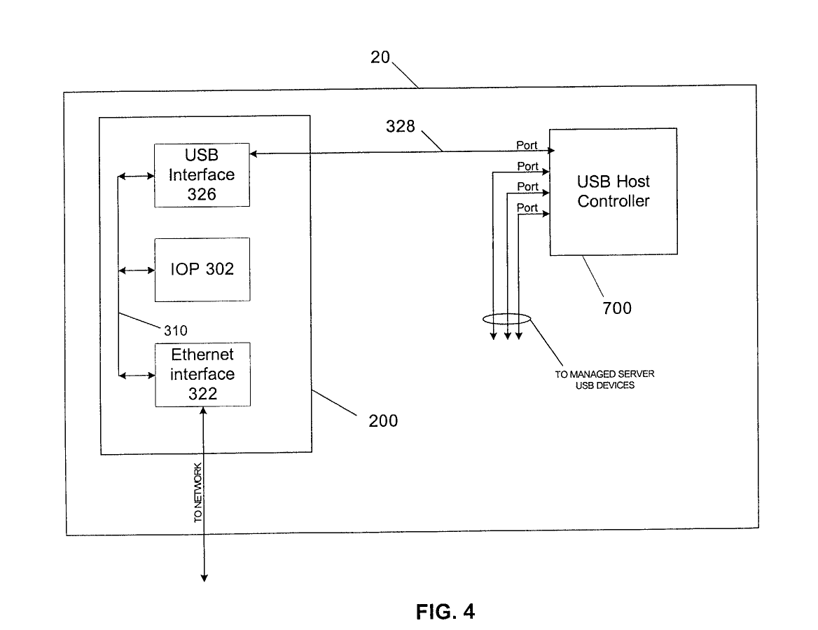

Embedded I/O controller 300 further comprises a USB interface 326, which is operatively coupled to the internal local bus 310. The USB interface 326 is connected to a USB host controller (see FIG. 4) via a USB host controller interface 328.

The second major functional block of the remote server management controller 200 is the slave instrumentation module 400. The primary purpose of the slave instrumentation module 400 is to provide the hardware infrastructure to implement control and monitoring functions in the managed server 20 (FIG. 1) as dictated by the IOP 302 in conjunction with dedicated application software such as remote console management software running on a client computer.

The slave instrumentation module 400 comprises an automatic server recovery (“ASR”) controller 402, which operates to automatically respond to catastrophic failures of the managed server 20 (FIG. 1). The ASR controller 402 is operatively coupled to the internal local bus 310. The ASR controller 402 continually monitors whether the OS of the managed server 20 (FIG. 1) is operational by controlling a dead-man timer that requires periodic servicing by the OS. If the OS of the managed server 20 (FIG. 1) does not service the dead-man timer within a predetermined time, the ASR controller 402 resets the processor of the managed server 20 (FIG. 1) causing the managed server 20 (FIG. 1) to reboot.

A general purpose input/output module (“GPIO”) 405 is provided in the exemplary embodiment of the slave instrumentation module 400. The GPIO provides a versatile communication interface that may be used for a wide variety of purposes.

The slave instrumentation module 400 also comprises a JTAG master 404. The JTAG master 404 is operatively coupled to the internal local bus 310. The JTAG master 404 comprises a standard JTAG interface 406, which is operatively coupled to a corresponding standard JTAG interface (not shown) on the motherboard of the managed server 20 (FIG. 1). Through the JTAG master 404, the remote server management controller 200 can perform a wide range of control functions on the managed server 20 (FIG. 1). These functions include updating or repairing the BIOS of the managed server 20 by reprogramming the non-volatile memory where the BIOS resides.

The slave instrumentation module 400 further comprises an I²C master 408, which is operatively coupled with the internal local bus 310. The I²C master 408 has the capability of controlling a plurality of independent I²C serial channels 410. For purposes of example only, four (4) separate I²C channels are shown in FIG. 2. The I²C master 408 comprises a separate I²C engine for controlling each separate I²C channel.

The slave instrumentation module 400 additionally comprises a block of system support logic 412. The system support logic 412 is operatively coupled to the internal local bus 310. The system support logic 412 provides a variety of housekeeping and security functions for the managed server 20. Examples of these functions include providing the EISA bus ID, flash ROM support, ECC support, hot spare boot support, system post monitor support, floppy write protect, SMI base security measures, open hood detection and the like.

The third and final major functional block of the remote server management controller 200 is the remote console redirection module 500, which comprises a video encoder 502 and integrated remote console (“IRC”) registers 504. The IRC registers 504 receive raw data snooped from the PCI bus 314. Under control of the IOP 302, some of the IRC registers 504 may function as a virtual communication device (“VCD”) that may be used to intercept UART communications or communications from other sources. Data intercepted through the VCD may be altered by the IOP and/or redirected to other outputs of the remote server management controller 200. For example, data intercepted by the VCD may be redirected to a remote user via the Ethernet interface 322.

In one exemplary embodiment of the remote server management controller of the present invention, the VCD presents a virtual 16550 UART to the internal architecture of managed server 20 (FIG. 1). The VCD logic enables the remote server management controller 200 to communicate with specific OS features, such as the Emergency Management Services (“EMS”) facility that is implemented in Windows XP. These OS specific features are designed to communicate with a physical UART or USB device. The remote management controller 200 emulates these physical devices so that the OS features can be seamlessly extended to remote users.

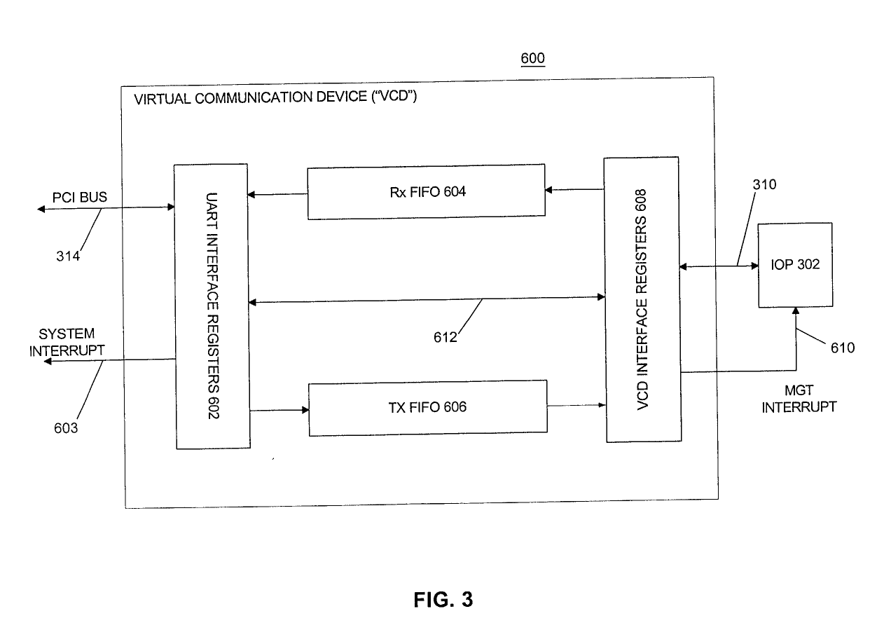

FIG. 3 shows a functional block diagram of a virtual communication device (“VCD”) 600, which may comprise some of the IRC registers 504 in the remote console redirection module 500. The VCD 600 operates under the control of the IOP 302 (FIG. 2).

The VCD 600 comprises a set of UART interface registers 602. In an exemplary embodiment of the invention, the VCD emulates a standard 16550 UART so the UART interface registers correspond to the registers of a 16550 UART. Alternatively, the VCD could emulate other UARTs, such as the 16450 UART. The type of UART emulated by the VCD is not a crucial aspect of the invention. The UART interface registers 602 are operatively connected to the PCI bus 314 (FIG. 2) to both snoop transactions on the PCI bus 314 (FIG. 2) and respond as a PCI device. The UART interface registers 602 are also adapted to provide a system interrupt 603 to the CPU of the managed server 20 (FIG. 2).

A set of VCD interface registers 608 is operatively connected to a receive FIFO 604 and a transmit FIFO 606. The receive FIFO 604 is adapted to pass data from the VCD interface registers 608 to the 16550 interface registers 602. The transmit FIFO 606 is adapted to pass data from the 16550 interface registers 602 to the VCD interface registers 606. Control logic 612 is operatively coupled between the 16550 interface registers 602 to the VCD interface registers 606.

The VCD interface registers 608 are operatively connected to the IOP 302 via the internal local bus 310. The IOP 302 is adapted to be interrupted by the VCD interface registers 606 via a management interrupt signal 610.

During a boot of the managed server 20 (FIG. 1), the OS typically looks for the presence of a serial port by reading and writing to known locations in register space. When the system management controller wishes to connect to the OS through this interface (e.g. remote user is requesting this service), the VCD 600 may intercept these cycles on the PCI bus 314 and perform an emulated function instead. Under certain conditions, the VCD 600 may request the assistance of firmware running on the IOP to complete the function. The request of the VCD 600 may be initiated using the management interrupt signal 610.

The following section describes the registers that are emulated by the VCD functionality of the remote console redirection module 500. The registers can be mapped to one of four possible legacy address regions depending upon configuration. These legacy I/O addresses corresponding to COM 1, COM 2, COM 3 and COM 4 are shown in Table 2:

TABLE 2
I/O Port Addresses for Serial Communications

| COM 1 | COM 2 | COM 3 | COM 4 | Function | Abbreviation |
|---|---|---|---|---|---|
| 3F8h | 2F8h | 3E8h | 2E8h | Receive Buffer | RB |
| | | | | (Reads) Transmit | TB |
| | | | | Holding Register | |
| | | | | (Writes) | |
| | | | | Baud Rate Divisor | BRDL |
| | | | | Low (When Baud | |
| | | | | Latch Enabled) | |
| 3F9h | 2F9h | 3E9h | 2E9h | Interrupt Enable | IER |
| | | | | Register (Reads & | |
| | | | | Writes) | |
| | | | | Baud Rate Divisor | BRDH |
| | | | | High (When Baud | |
| | | | | Latch Enabled) | |
| 3FAh | 2FAh | 3Eah | 2EAh | Interrupt | IIR |
| | | | | Identification | |
| | | | | Register (Reads) | |
| | | | | FIFO Control | FCR |
| | | | | Register (Writes) | |
| 3FBh | 2FBh | 3Ebh | 2EBh | Line Control | LCR |
| | | | | Register | |
| | | | | (Reads & Writes) | |
| 3FCh | 2FCh | 3Ech | 2ECh | Modem Control | MCR |
| | | | | Register | |
| | | | | (Reads & Writes) | |
| 3FDh | 2FDh | 3Edh | 2EDh | Line Status Register | LSR |
| | | | | (Reads & Writes) | |
| 3FEh | 2FEh | 3Eeh | 2EEh | Modem Status | MSR |
| | | | | Register | |
| | | | | (Reads & Writes) | |
| 3FFh | 2FFh | 3Efh | 2EFh | Programmer's | PSR |
| | | | | Scratch Register | |

Additionally, the VCD 600 may map the emulated UART registers to a non-legacy address. This allows the emulated COM port to exist anywhere within PCI address space. This address can be communicated to the OS of the managed server 20 (FIG. 1) through a BIOS-supplied system description table, such as the Advanced Configuration and Power Management Interface (ACPI) promulgated by Microsoft, Toshiba, Intel, and Compaq.

Modem server operating systems are beginning to support basic server management functionality. In some cases, such as with the EMS facility of Windows XP, the OS supports a management interface that communicates with an external port of the managed server 20 (FIG. 1), such as a serial port. Some or all of the information available via the EMS may be of assistance to a remote user trying to diagnose a problem on the managed server 20. By enabling the VCD, the remote server management controller 200 presents an interface that is natively supported by the OS management interface, allowing the IOP 302 to communicate with the OS management interface. In this way, the remote server management controller 200 (FIG. 2) may exploit the functionality of the OS to become privy to information known at the OS level of the managed server 20 (FIG. 1), but which is not otherwise easily accessible to the remote server management controller 200.

Those of ordinary skill in the field will appreciate that the functionality of the VCD 600 may also be achieved using actual UARTs instead of the VCD 600. For example, a user could engage in a management communication session via a serial port (incorporating a UART) of the managed server 20 (FIG. 1). The remote server management controller may be adapted to intercept communications from the serial port and to redirect responses using a UART incorporated into the UART interface 316.

FIG. 4 is a functional block diagram showing an operating environment of a remote server management controller USB interface in a managed server. In the exemplary embodiment, the USB interface 326 is connected via USB host controller interface 328 to one port of a USB host controller 700, which is typically located in a south bridge portion of the chipset (not shown) of the managed server 20. The other ports of the USB host controller 700 may be connected to other USB peripherals or external connectors that are local to the managed server 20.

When implemented in this way, the IOP 302 of the remote server management controller 200 may establish “virtual USB peripherals” that will be seen and recognized by any USB-aware OS or properly adapted system BIOS. These virtual peripherals allow communication with the OS in a common, OS-independent manner.

The USB interface 326 provides the functionality to interface a variety of peripheral devices to the USB bus of the managed server 20 via the USB host controller 700. The virtual USB devices provided by the remote server management controller 200 may be implemented as a USB composite device comprising (for example) a keyboard, a mouse, a floppy diskette drive, a CD-ROM drive and/or a network interface controller.

The USB interface 326 handles the USB protocol functions and interfaces to the IOP 302 via the internal local bus 310. A single active-low signal may be provided to flag Interrupts to the IOP 302. Status indications from the various functional areas of the USB interface 326 may be ORed together to activate the interrupt signal. The IOP 302 may be associated with a number of internal status registers to allow quick identification the functional device that is the source of the interrupt.

USB keyboards, USB mice, USB floppy drives, USB CD drives and USB Ethernet controllers are just a few examples of the wide range of USB devices that could be emulated by the IOP 302 via the USB interface 326. The ability to emulate USB keyboards and mice allows the remote server management controller 200 to create a “legacy free” system environment. As the eventual removal of the traditional 8042-style keyboard controller from computer system architecture becomes a reality, the ability of prior art remote server management tools to provide traditional remote keyboard functionality will become irrelevant. The USB device emulation provided by USB interface 326 provides a way to deliver keystrokes and mouse status updates to the OS of a managed server even if the managed server does not have an 8042 keyboard controller.

When a remote user initiates a management communication session with the remote server management controller 200 via an external interface such as the Ethernet interface 322, the USB interface may be adapted to receive keyboard and mouse commands transmitted by the remote user. Those keyboard and mouse commands are passed to the OS of the managed server 20, allowing the remote user to exercise control of the managed server as though he/she were present at the managed server 20.

USB storage devices (such as floppy drives and CD-ROM drives) provide additional capability from a remote management point of view because the USB interface 326 allows the remote server management controller 200 to act as a host for hot-pluggable storage devices. This capability allows remote server management controller 200 to mount additional storage volumes to the managed server 20 (FIG. 1) in an OS-independent fashion. Ideally, the USB storage volumes would reside on an application such as a remote management console, giving a remote user the ability to load programs to or store data from the managed server 20 via a CD-ROM drive and/or floppy drive connected directly to the client computer being used by the remote user. Other emulated devices, such as an Ethernet controller, may provide additional capability because the USB interface gives the remote server management controller 200 a well-defined, hot-plug interface for communication without requiring a specific proprietary device driver.

The USB interface 326 may also be used to pass requests from remote users to management facilities of the OS if the OS has the capability of communicating via the USB host controller 700 of the managed server 20. This functionality is similar to the functionality provided by the VCD 600 (see discussion of FIG. 3 above), which provides an interface to OS management facilities that communicate via UARTs, such as the Emergency Management Services facility of Windows XP.

The USB interface 326 will typically comply with the particular USB device class used by the specific OS of the managed server 20 (FIG. 1) to provide management information. The USB interface 326 may use the USB communication device class, as it provides similar functionality to UART interfaces currently in use. Alternatively, the USB interface 326 may use a customized device class that is designed to fit the needs of a management service feature of a modern operating system, such as the EMS facility of Windows XP.

Those of ordinary skill in the field will appreciate that functionality described with respect to the USB interface 326 in FIG. 4 may be obtained with other communications interfaces as well. For example, the remote server management controller 200 may incorporate an interface that is compatible with the IEEE 1394 or IEEE 1394b standards in addition to or instead of a USB interface. If an interface for either IEEE 1394 or IEEE 1394b is incorporated into the remote server management controller 200, that interface may be adapted to redirect communications and emulate devices compatible with that interface.

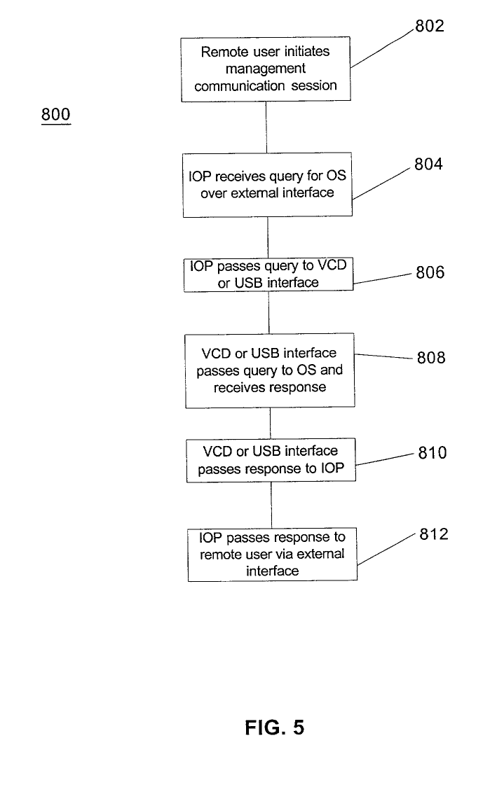

FIG. 5 is a process flow diagram showing an exemplary process of remotely communicating with the OS of the managed server 20 (FIG. 1). As set forth above, modem server OSes, such as Windows XP, employ a level of management support. The management support may be exploited by the remote server management controller 200 via the VCD 600 or the USB interface 326 as described above to allow a remote user to obtain access to data from the OS that would otherwise be unavailable or difficult to obtain. The overall process shown in FIG. 5 is generally referred to by reference numeral 800. In the exemplary embodiment, the remote user may address communications to the OS of the managed server 20 through either the VCD 600 (FIG. 3) or the USB interface 326 (FIG. 4), depending upon which interface is used by the OS of the managed server 20 to support management communications.

At 802, a remote user initiates an out-of-band communication with the remote server management controller 200 (FIG. 2) via the Ethernet interface 322 (FIG. 2). As part of this session, the user desires to obtain information about the status of the OS of the managed server 20 (FIG. 1). The user may issue a query to be passed on to the OS through a management facility that is supported by the OS.

The user's query is received by the IOP 302 at 804 and directed to the VCD or USB interface 326 at 806, depending on which interface is employed by the OS of the managed server 20 for management communications. The VCD 600 or USB interface 326 passes the user's request to the OS via the OS-supported management facility at 808 and receives the response back from the OS. The VCD 600 or USB interface 326 passes the response of the OS back to the IOP 302 at 810 and the IOP 302 transmits the response back to the user via the Ethernet interface 322 at 812.

The capability provided by the VCD 600 and/or the USB interface 326 allows the IOP 302 to combine “OS-dependent” management data and native “OS-independent” information together. This is a very powerful tool, which allows a user to request both types of data and receive that data through one unified and consolidated interface. The OS-independent capability of the VCD 600 and USB interface 326 may be employed to reduce the cost of remote management implementation because they eliminate the need for costly terminal servers.

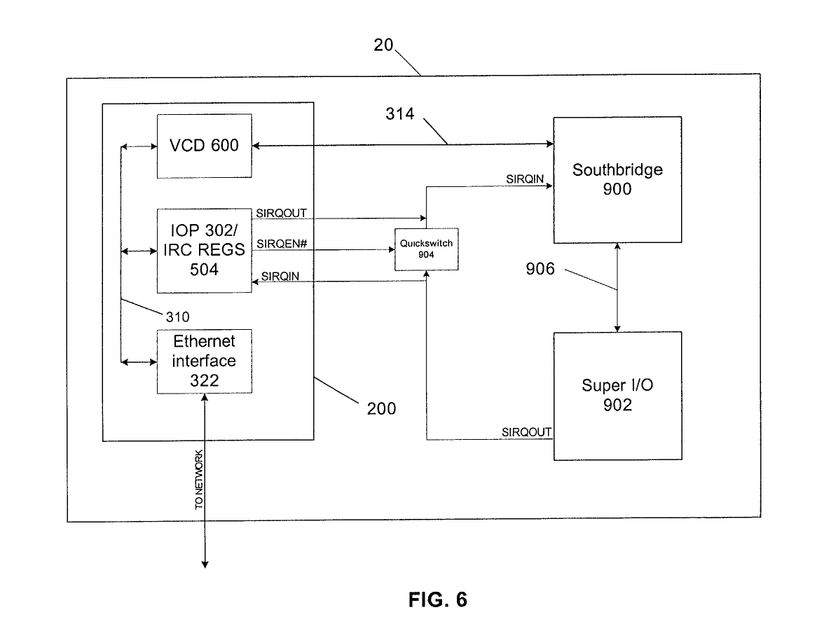

Turning now to FIG. 6, the VCD 600 of the remote server management controller 200 is adaptable to many uses. One such use is to allow the managed server to employ a modem serial interrupt structure while preserving some uses of legacy interrupt methodologies. FIG. 6 is a functional block diagram illustrating one exemplary embodiment of the interrupt handling functionality of the remote server management controller 200.

The VCD 600 is connected to the PCI bus 314 of the managed server 20. Also connected to the PCI bus 314 is a southbridge 900, which provides support functions to the CPU (not shown) of the managed server 20. The southbridge is connected to a typical Super I/O device (“SIO”) 902, which provides many low level input/output functions for the managed server 20. Typical SIOs function as a collection of legacy devices, such as UARTs (which may be configured as COM ports), parallel ports, floppy drive control, keyboard control and/or mouse control. The southbridge 900 is connected to the SIO 902 by a data path 906, which may be a bus such as a low pin count bus.

In many newly developed servers, legacy ISA interrupts are no longer supported. Instead, interrupts are transmitted serially to the southbridge of the server using one signal with a defined protocol. Usually an SIO is the source of these interrupts, but other devices can generate interrupts as well. In order for a keyboard, mouse, or serial port to be emulated or shared between the remote server management controller 200 and the managed server 20, the respective interrupts from those devices may be intercepted by the remote server management controller 200. In order to mask or generate a device interrupt without interference from the respective device or the device driver, the present embodiment provides logic to allow any interrupt in the serial stream to be blocked or artificially generated by another device such as the VCD 600 under control of the IOP 302.

The architecture of the remote server management controller 200 attempts to eliminate as many ties to the aging ISA architecture as possible to facilitate its use in “legacy-free” server designs. Usage of ISA interrupts in prior remote management tools presented problems because, for example, modern operating systems were not capable of recognizing a PCI device connected to ISA interrupts. Certain system interface functions and emerging industry standards, however, continue to force the need for non-PCI interrupt events. The Intelligent Power Management Interface specification (“IPMI”), for instance, is a relatively new industry standard, but it only provides for an ISA-like interrupt implementation. For example, the IPMI specification does not include a standard discovery mechanism like the PCI specification does. Microsoft's Windows XP OS includes an Emergency Management Services feature, which also attempts to standardize a legacy-bound interrupt implementation. To comply with these standards, emulation of legacy interrupts is important.

Legacy ISA interrupts IRQ3, IRQ4, and IRQ5 are routed through the remote server management controller 200 to provide COM port emulation to the IOP 302. As described above, COM port emulation also allows the IOP 302 to redirect management communications from OSes such as Windows XP to the Ethernet interface 322.

The exemplary embodiment, the architecture of the remote server management controller supports interception of IRQ3, IRQ4 and IRQ 5, but interception of other interrupts may be supported as well. The remote server management controller 200 (FIG. 2) typically provides three pins to perform interrupt interception and redirection: SIRQIN, SIRQOUT, and SIRQEN#.

As shown in FIG. 6, a typical quickswitch 904 is positioned between the serial interrupt output (SIRQOUT) of the SIO 902 and the serial interrupt input (SIRQIN) of the southbridge 900. The SIRQOUT signal from the SIO 902 is also routed to an SIRQIN input on the IOP 302. An SIRQOUT signal is connected as an output from the IOP 302 to the other side of the quickswitch 904. An SIRQEN# control signal is connected as an output from the IOP 302 to the enable pin (not shown) of the quickswitch 904.

When connected in this manner, the IOP 302 may monitor the serial interrupt data stream that is passed from the SIO 902 to the southbridge 900. As long as the IOP does not assert its SIRQEN# control signal, the serial interrupt data continues to flow from the SIO 902 through the quickswitch 904 to the southbridge 900. If the IOP, asserts the SIRQEN# control signal, the output of the quickswitch 904 is placed into a high impedance state (“tristated”). This allows the IOP 302 to transmit its own serial interrupt data from its SIRQOUT pin to the southbridge 900.

This technique allows the remote server management controller 200 (FIG. 2) to monitor and/or redirect interrupts such as IRQ3, IRQ4, and/or IRQ5 from the SIO 904 to the IOP 302 (FIG. 2). The IOP 302 may use this capability of the remote server management controller 200 to interrupt the managed server 20 by inserting its own internally generated interrupt into the serial interrupt data transmitted from the SIO 902 to the southbridge 900.

When the CPU of the managed server responds to the interrupts generated by the IOP via the PCI bus 314, the VCD 600 may be adapted to intercept the response, prevent the response from reaching the SIO 902 and, instead, redirecting it to the IOP 302. In this manner, the remote server management controller may effectively emulate any I/O device supported by the SIO 902 without interfering with the operation of the managed server 20.

A remote user may take advantage of the COM port emulation capability during a remote management session with the remote server management controller 200. The remote user may initiate a remote session over the Ethernet interface 322 and command the IOP to emulate a device that is supported by the SIO 902. The IOP 302 may be programmed to respond to the user's requests and provide responsive data to the user via the Ethernet interface 322.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A remote server management controller, comprising:
an external communication interface adapted to receive data from a remote user;
an IOP adapted to:
receive data from the external communication interface; and
transmit data corresponding to the data received from the external communication interface to an OS of a managed server; and
a VCD interface adapted to intercept data received from the OS, the data received from the OS being intended for a specific communication interface, and to redirect the data received from the OS to the remote user via the external communication interface instead of directing the data received from the OS to the specific communication interface.

2. The remote server management controller of claim 1, wherein the specific communication interface is a UART interface of the managed server.

3. The remote server management controller of claim 1, wherein the specific communication interface is a USB host controller of the managed server.

4. The remote server management controller of claim 1, wherein data received from the user over the external communication interface is transmitted to the OS of the managed server via a UART interface.

5. The remote server management controller of claim 1, wherein data received from the user over the external communication interface is transmitted to the OS of the managed server via a USB interface.

6. The remote server management controller of claim 1, wherein the specific communication interface is a 1394 interface of the managed server.

7. The remote server management controller of claim 1, wherein data received from the user over the external communication interface is transmitted to the OS of the managed server via a 1394 interface.

8. The remote server management controller of claim 1, wherein the external communication interface is an Ethernet interface.

9. A remote server management controller, comprising:
an IOP adapted to monitor interrupt data transmitted from an SIO to a southbridge, to alter the interrupt data transmitted from the SIO based on input received from an external user via an external communication interface and to transmit the altered interrupt data to a managed server; and
a VCD adapted to:
intercept responsive data intended to be transmitted to the SIO in response to the altered interrupt data; and
prevent the responsive data from reaching the SIO.

10. The remote server management controller of claim 9 wherein the VCD is further adapted to route the responsive data to the remote user via the external communication interface.

11. The remote server management controller of claim 9 wherein the input received from the external user is adapted to emulate an interrupt generated by a device in the managed server.

12. The remote server management controller of claim 9 wherein the external communication interface is an Ethernet interface.

13. A method of remotely retrieving data from an OS, the method comprising the acts of:
receiving a request for OS information from a remote user;
transmitting the request for OS information to the OS;
receiving data responsive to the act of transmitting the request to the OS, the data being intended for a specific communication interface;
redirecting the data received from the OS responsive to the act of transmitting the request to the OS to the remote user instead of to the specific communication interface.

14. The method of claim 13 wherein the specific communication interface is a UART interface.

15. The method of claim 13 wherein the specific communication interface is a USB interface.

16. The method of claim 13 wherein the specific communication interface is a 1394 interface.

17. The method of claim 13 further comprising the act of enabling an Ethernet interface to receive the request for OS information.

18. The method of claim 13 further comprising the act of initiating an out-of-band management communication session.

19. The method of claim 13 further comprising the act of enabling a VCD to transmit the request for OS information to the OS.

20. The method of claim 13 wherein the recited acts are performed in the recited order.
